(19) United States
(12) Patent Application Publication
(10) Pub. No.: US 2021/0357841 A1
(43) Pub. Date: Nov. 18, 2021

(54) Method and System for Monitoring Accountability and Fairness for An Enterprises

(71) Applicant: Sanjeevani Krishna Kamalakar, Thane (West) (IN)

(72) Inventor: Sanjeevani Krishna Kamalakar, Thane (West) (IN)

(21) Appl. No.: 15/931,667

(22) Filed: May 14, 2020

(51) Int. Cl. G06Q 10/06; G06Q 10/10

(52) U.S. Cl. CPC G06Q 10/06393; G06Q 10/103; G06Q 10/06398; G06Q 10/06313; G06Q 10/063114; G06Q 10/06395

(57) ABSTRACT

An automated system & method for real time monitoring and enhancing performance for an enterprise is disclosed herein. The present invention measures the performance objectively, instead of subjective measurement. The system comprises of plurality of electronic devices (1), a remote server (3), and an interface (2) providing link between the electronic devices (1) and the remote server (3), The system of the present invention facilitates time scheduling, parameter setting, progress updation, resource planning, task initiation, survey management and feedback, leave of absence and loss of pay management for the enterprise, day planning and management for the task executor, automated recovery in case of collapse of schedule and such.

### CROSS-REFERENCE TO RELATED APPLICATION

This application claims priority from a Patent Application filed in India bearing application no. 201721040767, filed on Nov. 15, 2017 and titled “A Method and System for Monitoring Accountability and Fairness for An Enterprises”.

### FIELD OF INVENTION

The present invention relates to an automated system and method for monitoring a performance of an organisation to its optimum, and process thereof.

### BACKGROUND AND PRIOR ARTS

In case of a company or any organisation, resources at all levels in an organization most often do not work with their full potential which leads to failures and unproductivity. The reasons of a resource not working to the full potential include lack of clarity on priorities, forgetfulness on a few tasks, lack of accountability on the part of the resources, improper resource utilization, lack of clarity on expectations among others. The performance of the organisation is, to an extent, directly related to the performance of the employees. It is, therefore, a routine in any organisation to measure the performance of the employees.

There are some patent documents which disclose computer implemented method to measure the performance of an employee within the organisation. For example, U.S. Pat. No. 8,326,681 discloses methods and mechanisms for determining performance proficiency within an organization. The method includes receiving rating data that includes one or more values that are each associated with an element and each element describes a specific rating criterion associated with a specific rating subject. The method additionally includes producing a hierarchical data structure responsive to the receipt of the rating data that includes at least one category and each category includes at least one factor having at least one element. The method further includes generating a rating schema based on the hierarchical data structure. The method may additionally include providing the rating schema to a client and the value within each element may define an ability of a rating subject. Each value associated with an element may be a numerical value.

Another document EP1424646 discloses performance monitoring system receives data from one or more data sources. It transforms the received data into the performance information relating to predefined Key Performance Indicators (KPIs); and stores it into a KPI store. The system also calculates scores based on the received data and the performance information stored in the KPI store. Thus, the system can indicate changes in the KPIs through an information presentation unit.

U.S. Pat. No. 8,744,904 discloses the system which enables multi-perspective employee data collection from various sources such as an employee's superiors, peers, subordinates, clients and the employee himself. The system also permits a participant to select persons whose employment performance the employee desires to review but is not obligated to review. The system requires a managerial approval or denial both the reviewers an employee may select to review his or her performance and the reviewees the reviewer chooses to review. The system also permits managers or mentors to receive interim employee performance feedback and generate interim employee action plans between annual performance evaluations. In addition, the system permits a user to download the application and participate in the system's employee performance surveys while offline and disconnected from the corporate intranet or the World Wide Web.

However, the systems and methods in the aforesaid prior arts do not assist the organisation in managing its own human resources to complete a task or a project. Further, the systems and methods in the aforesaid prior arts do not assist the individual in managing his/her task and hence raising his/her own productivity. In all, the prior arts do not assist the organisation to optimise its own performance. Furthermore and perhaps most importantly, the performance monitoring in the stated prior arts is not real time and does not depend upon the real time data. Particularly, the inputs gathered in the aforesaid prior arts are subjective inputs.

Hence, there is a need to address the aforesaid issues and drawbacks, and to introduce a simple, data driven, real-time method/system to monitor the performance of the resources in an organisation. Also, there is a need to provide real-time feedback to improve performance of the employee and, in turn, that of the organisation. Most importantly, there is a need to provide a system & method that measures the performance of the employee as well as the organisation objectively.

### SUMMARY OF INVENTION

It is a primary object of the invention to contribute to the efforts of optimising the collective performance of the organisation and increase its collective efficiency.

Further, it is an object of the invention to assist the organisation to automate management of its own human resources to complete a task or a project or a process in a timely manner and in accordance with organisations performance parameters.

Additionally, the instant invention assists the individual in managing his/her task and hence raising his/her own productivity.

Accordingly, an automated system and method for optimising a performance of an organisation is disclosed herein. The system comprises plurality of electronic devices configured to receive proposed tasks and submit completed tasks; an interface and a remote server configured to receive, store information relating to the tasks; wherein the remote server is capable of:
defining and standardising plurality of parameters before generating tasks/projects/processes;
determining acceptable deviations from the standardised parameters before generating tasks/projects/processes;
managing resources by verifying availability of executor before assigning the tasks/projects/processes to the executor;
accepting/rejecting the tasks/projects/processes submitted by the executors based on quality;
determining quality of the submitted tasks/projects/processes by verifying whether submitted tasks/projects/processes are within the acceptable deviations from the standardised parameters;
initiating a failure recovery mode if the submitted tasks/projects/processes are not within the acceptable deviations from the standardised parameters;
computing scores and penalties of resources based on quality of tasks/projects/processes;
computing impact on the enterprise in case of delays meeting timeline, rework, change of scope, resource balancing; and
self-generating recommendations based on delays/deviation in performance parameters.

The system of the present invention facilitates time scheduling, parameter setting, progress updation, resource planning, task initiation, survey management and feedback, leave of absence and loss of pay management for the enterprise, day planning and management for the task executor, automated recovery in case of collapse of schedule and such.

The KPIs may be constructed by linking the defined KPIs to all the tasks taking place in the organisation, calculating scores against each task and integrating the same.

The set parameters may include timeline for the completion of tasks, the accuracy by which the task is completed, other parameters such as budget, revenue, process compliance etc.

Further, the present invention discloses an automated method for monitoring and enhancing performance of an enterprise in an objective manner. The method comprises steps of:
defining and standardising plurality of parameters before generating tasks/projects/processes;
determining acceptable deviations from the standardised parameters before generating tasks/projects/processes;
managing resources by verifying availability of executor before assigning the tasks/projects/processes to the executor;
accepting/rejecting the tasks/projects/processes submitted by the executors based on quality;
determining quality of the submitted tasks/projects/processes by verifying whether submitted tasks/projects/processes are within the acceptable deviations from the standardised parameters;
initiating a failure recovery mode if the submitted tasks/projects/processes are not within the acceptable deviations from the standardised parameters;
computing scores and penalties of resources based on quality of tasks/projects/processes;
computing impact on the enterprise in case of delays meeting timeline, rework, change of scope, resource balancing; and
self-generating recommendations based on delays/deviation in performance parameters.

The method of the present invention is a repetitive.

### BRIEF DESCRIPTION OF DRAWINGS:

FIG. 1 illustrates components of the system disclosed in the present invention

FIG. 2 illustrates a flowchart defining/standardising parameters

FIG. 3 illustrates initiation of project/process

FIG. 4(a) illustrates computation of task score

FIG. 4(b) illustrates computation of project score

FIG. 4(c) illustrates computation of process score

FIG. 4(d) illustrates computation of enterprise score

FIG. 4(e) illustrates computation of managerial score

FIG. 4(f) illustrates total score achieved by the user as computed by the system.

FIG. 4(g) demonstrates computation of the total score achieved by the enterprise.

FIG. 5(a) illustrates flowchart showing the task distribution

FIG. 5(b) illustrates a work-flow of prioritisation of the task

FIGS. 6(a) & 6(b) illustrate failure recovery mode of the present invention.

FIG. 7 illustrates resource management and balancing by the system.

FIG. 8 illustrates customer satisfaction scores evaluation by the system.

FIG. 9 illustrates system generated impact notifications due to delays.

FIG. 10 illustrates recommendations generated by the system of the present invention to proactively take corrective actions.

### DETAILED DESCRIPTION:

In accordance with the aforementioned objectives, the present invention describes an automated system and method for optimising a performance of an organisation.

The KPIs may be constructed by linking the defined KPIs to all the tasks taking place in the organisation, calculating scores against each task and integrating the same.

The set parameters may include timeline for the completion of tasks, the accuracy by which the task is completed, other parameters such as budget, revenue, process compliance etc.

The invention provides configurable platform to feed in following information required to reliably automate every resource's day.

a. organisation goals, b. Resource hierarchy, c. Task with owners, Performance parameters and respective parameter's weightages, d. Processes, e. Projects, f. Calendar, g. Quality Documents, h. Authority Matrix, i. Audit role

When the projects or processes are launched, the tasks are displayed on the individual dashboards of the task executor, team member, supervisor and project/process owner as per their respective role for the task. The completion of tasks has a rating or scoring mechanism associated with it. The criteria for such rating or scoring mechanism include, but not limited to, defined turnaround time, quality criteria, budget etc. The task is scored based on task executors performance based on the performance parameters attached to the task, no. of rejection, HOLD, rework etc. For example, the task executor records higher or lower scores, based on tasks completed earlier or later than the turnaround time allotted for the task. As the task executor/s complete the tasks, newer tasks are assigned based on the pre-defined interdependencies of the completed and the new tasks. The cycle of population of the new tasks continues till the process or the project comes to a successful closure.

If the parameters of rating or scoring are not met adequately, then the system enters into the failure recovery mode.

Based on the performance data stored in the system, the system even suggests areas of improvement to the user.

The invention may be envisaged by referring to figures appended at the end of specification. However, it may be understood by person skilled in the art that the figures illustrate various embodiments, including best mode of performing the invention, and do not restrict the scope of the invention.

With reference to figures, the system of the present invention comprises plurality of electronic devices (1) configured to receive proposed tasks and submit completed tasks; an interface (2) and a remote server (3) configured to receive, store information relating to the tasks; wherein the remote server is capable of: defining and standardising plurality of parameters before generating tasks/projects/processes; determining acceptable deviations from the standardised parameters before generating tasks/projects/processes; managing resources by verifying availability of executor before assigning the tasks/projects/processes to the executor; accepting/rejecting the tasks/projects/processes submitted by the executors based on quality; determining quality of the submitted tasks/projects/processes by verifying whether submitted tasks/projects/processes are within the acceptable deviations from the standardised parameters; initiating a failure recovery mode if the submitted tasks/projects/processes are not within the acceptable deviations from the standardised parameters; computing scores and penalties of resources based on quality of tasks/projects/processes; computing impact on the enterprise in case of delays meeting timeline, rework, change of scope, resource balancing; and self-generating recommendations based on delays/deviation in performance parameters.

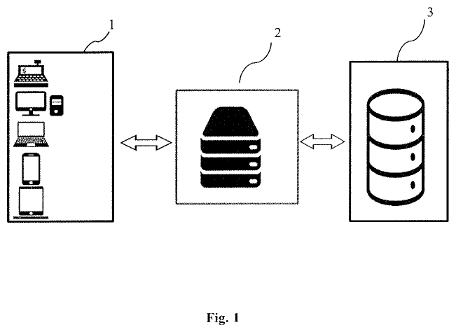

FIG. 1 shows the system having electronic devices (1), the remote server (3), and the user interface (2) that provides integration between the electronic devices (1) and the remote server (3).

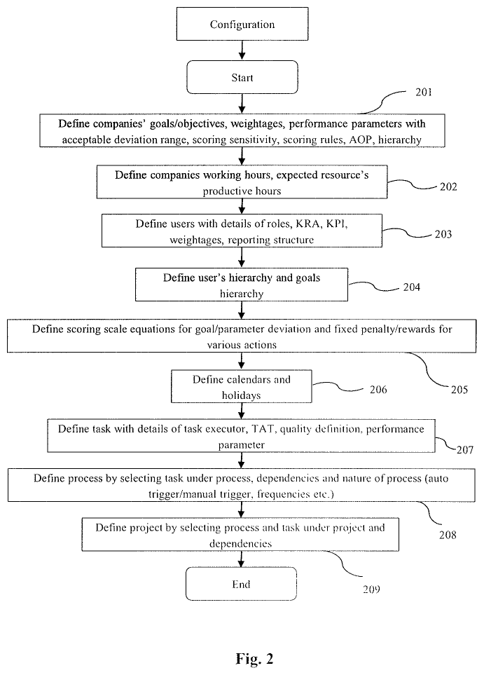

FIG. 2 is a flowchart that shows the different parameters being defined. The goals, hierarchies of the enterprise, performance standards with acceptable deviations are defined in step 201. The said parameters are based on organisations objectives/goals. The working hours, including expected productive hours, are defined in step 202. At step 203, Key Performance Indicator (KPI), Key Result Area (KRA) as well as roles of the employee/resources are defined. The hierarchies of goals are drawn according to the hierarchies of enterprise (step 204). The deviation from standardisation as well penalties, in case of goals not met, are defined at step 205. While deciding the goals of the enterprise, the working days, excluding holidays, are also noted (step 206). The task is listed along with the details of the executor, turn around time (TAT), and the standardisation (step 207). With these steps, a project is defined and comes into existence.

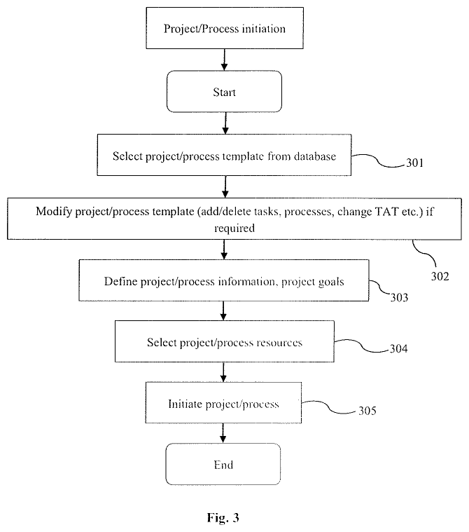

FIG. 3 illustrates the project/process being defined in the system. One can create standard project/process templates of an organisation. While initiating any new project/process, user can select relevant template available in the system. In step 3 303, user will define project/process information such as objective of launching process/project, customer information, performance parameters like cost, schedule, revenue etc. Step 304, resources working on the launched project/process, are selected based on availability of resources. Once project/process is initiated in step 305, task under project/process are populated in respective resources' dashboard.

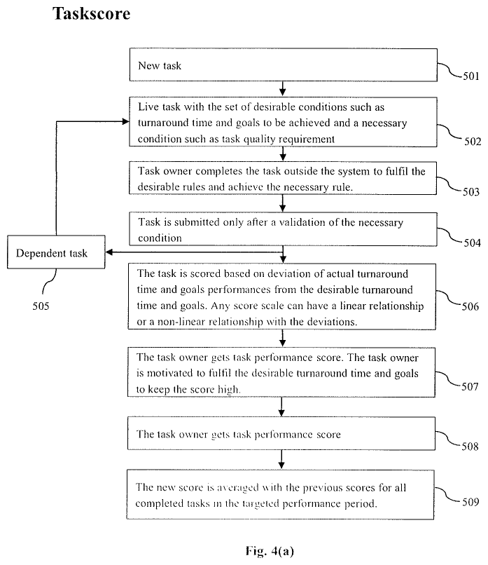

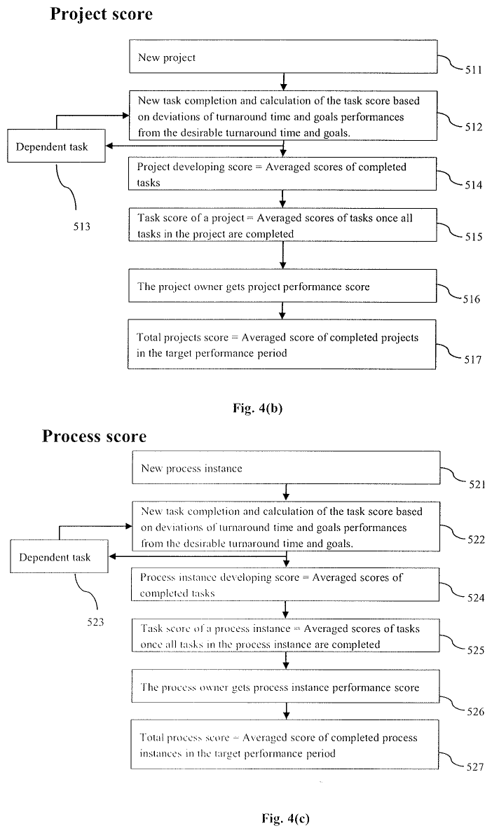

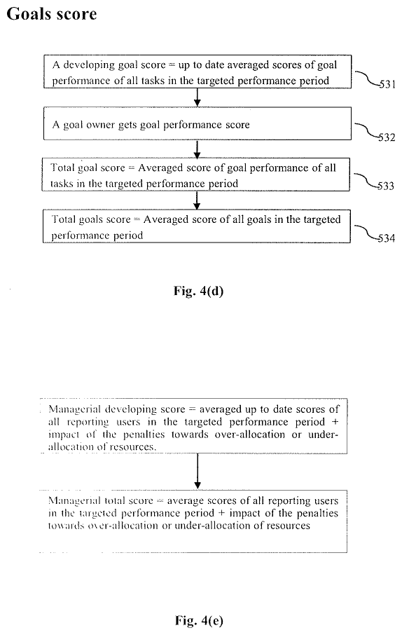

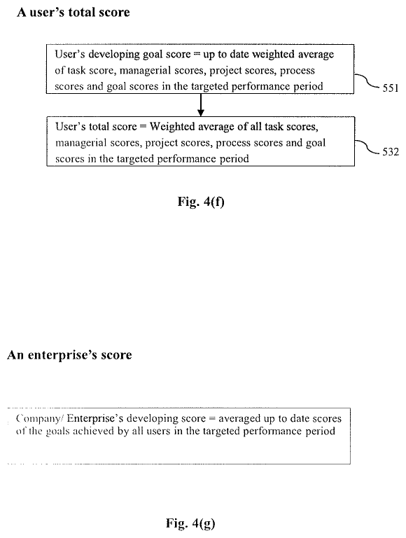

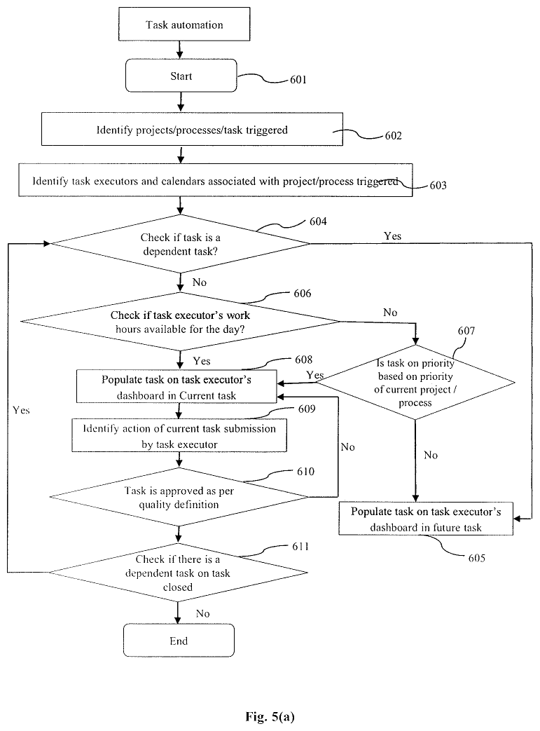

FIG. 4(a) demonstrates the scores based on the assigned task. It may be noted that this score is computed based on a single task. The total score is an average of such multiple task in a given time period. The task created carries the defined standards along with acceptable deviations with it (step 502). The dependant task does not become live till parent task is open (step 504) The dependant task becomes live when parent task is submitted by user (step 505). The score associated with task is computed, considering deviation in baseline TAT and other parameters and actual TAT and other parameters (step 506). The total score is averaged over all the scores in a given time period (509).

Similarly, steps 511-517 in FIG. 4(b) show computation of total score for projects completed over a period of time. The task score for each of the completed task is continuously computed, along with the completion of dependent task (steps 511 to 513). The parameters for computation of the scores are same as described before. During the continuation of the project, the project score is updated with each of the completed task and associated scores (step 514). After all the tasks are completed, total project score is averaged over all the completed tasks (step 515). The project performance score is assigned to the leader/owner of the project (step 516). The total projects score is computed as an average of all the projects' score in a specific period of time.

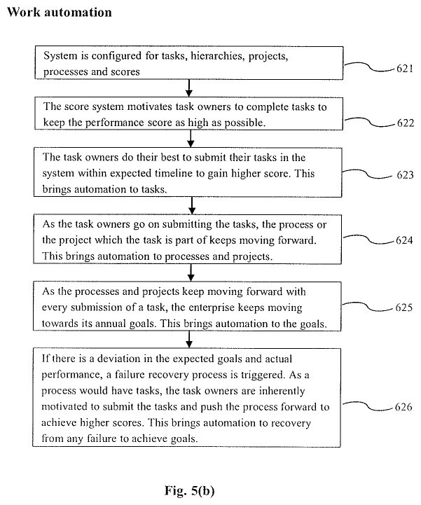

Similarly, the total process score is computed in a manner shown in FIG. 4(c). Steps 521-527 shown in FIG. 5(c) are identical to those in FIG. 4(b), except that the current figure relates to computation of process score.

FIG. 4(d) shows computation of scores for goals set by the organisation. A goal score is computed and updated in real-time by averaging scores of all set goals related to the tasks (step 531). This goal performance score is assigned to the person who has set these goals (step 532). The total goal scored is computed as average score of all the goals achieved in the specific time period (step 534).

Similarly, the managerial score is computed as an average scores of all the team members in a specific period of time (steps 541,542), as shown in FIG. 4(e). The figure shows that the manager score is compiled on the basis of the score of the team as a whole. The manager is also assigned with the score based on effective resource management. For example, the some of the resources may be overburdened while few others are under-utilised. In this case, the task distribution is not properly managed. While over utilised resource are rewarded, manager is penalised. Hence any bias resource management in an organisation is avoided.

FIG. 5(f) demonstrate computation of total score achieved by the user. The total score includes task score, project score, supervisory score and goal score.

FIG. 4(g) demonstrates computation of the total score achieved by the enterprise.

FIG. 5(a) illustrates a flowchart showing the task distribution, thereby assisting the task executor to arrange the task according to his/her convenience. Further, the system assists the enterprise to utilise its resources properly and wisely. When the task or project or process is generated, the system identifies the said task/project (step 602). The system also identifies the schedule of task executor as well as of the task (step 603). If the task/project is a dependent one, then the system lists the task/project as a future task (steps 604,605). However, if the task/project is not the dependent task/project, then the system verifies the working hours available on that particular day (step 606). If there are no sufficient working hours left on that day, then system first verifies a priority quotient of the said task/project (step 607). If the task/project is not on a priority basis, then it is listed as a future task/project (step 606). However, if the task/project is on a priority basis, then it is listed in current task/project (step 608). When the task/project is submitted by the task executor at his/her node, the system identifies the action of submission and compares the submitted task/project with the set standards (steps 609,610). If the completed task/project does not meet the standards then the system follows step 608. If the task/project is completed satisfactorily, then the system checks whether any task/project is dependent on the said completed task/project (step 611). This flowchart demonstrates that the system of the present invention essentially tries to figure out whether the task executor is overburdened with respect to the schedule associated with the said task/project/process. Due to the multiple checkpoints employed in the present invention, the productivity of enterprise increases significantly without exerting excessive work pressure on the employees. It also provides a scope for immediate recovery of lapses in set goals rather than retrospective analysis during periodic review.

FIG. 5(b) illustrates the work-flow of prioritisation of the task. The network/system determines whether the task is a dependent task (step 604). If the task is a dependent task, then the system assigns the task as a future task to the task executor (step 605). Otherwise, the system assigns this task as a priority task and asks the task executor to attend to the same immediately (step 607,608,609). The system further verifies task executor's action on the task and whether the task has attained the standards (steps 609,610).

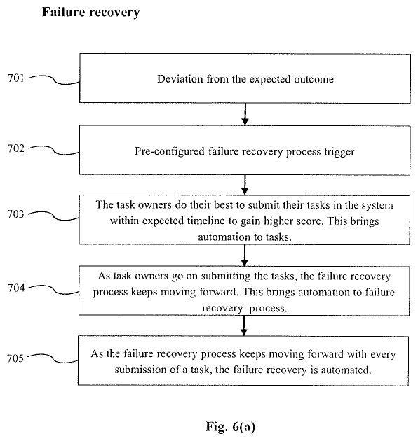

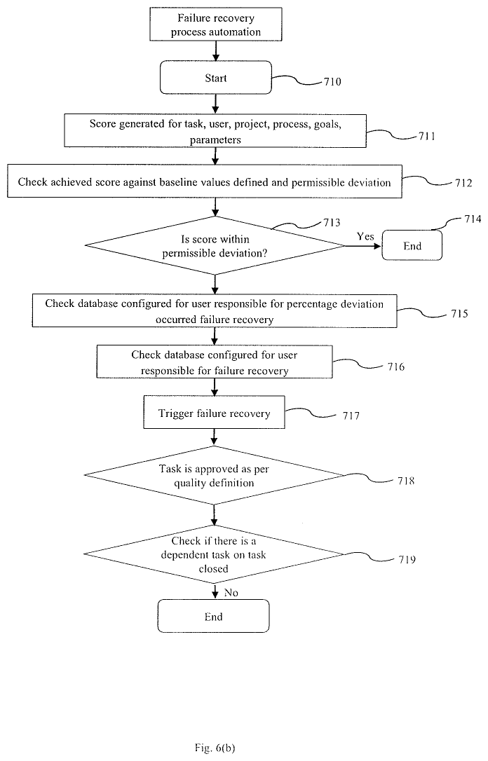

An embodiment of this invention includes a failure recovery mode, illustrated in FIGS. 6(a) & 6(b). The failure recovery mode is automatically activated only when the deviation is beyond permissible limits configured by each organisation (steps 701 & 702). The failure recovery process is configured as per organisation's process and hierarchy. As the task executor/owner keeps on submitting the task, the failure recovery mode keeps moving forward (steps 703,704,705). In FIG. 6(b), which shows initiation of failure recovery mode, the system compares the computed scores with the accepted range of deviation (steps 711,712,713). If the score is not within the permitted deviation, the system locates from which node/user the said discrepancy has taken place. The system, on it's own, suggests that particular node to match the set standards. When the task is approved, after meeting with the standards, the system verifies whether any dependent task is alive in order to address the associated discrepancy.

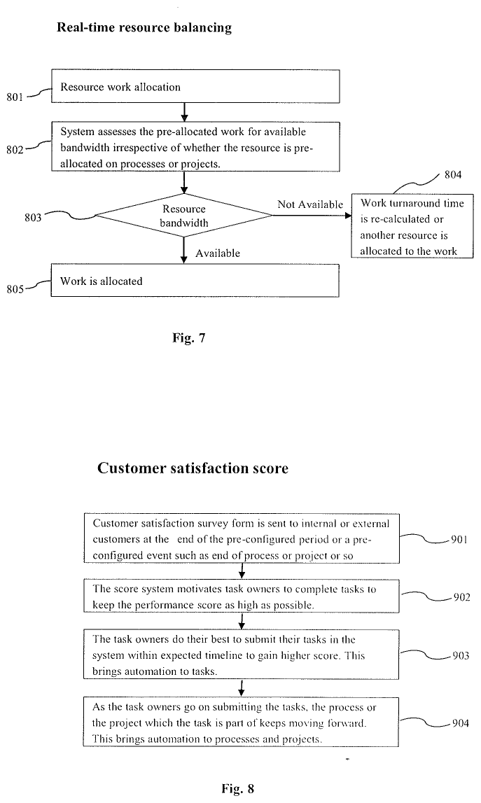

FIG. 7 explains how the system optimises resource utilisation. The system cross-verifies whether a particular resources are available to work on the newly generated task (step 801). If the absence of resource availability, it assigns the task to some other resource within the organisation (step 803).

FIG. 8 illustrates an embodiment in which the system seeks inputs from the end customer. The system calculates the customer satisfaction score and is updated along with previously calculated customer satisfaction score (step 903). This customer satisfaction score is calculated is averaged with other scores calculated before.

According to FIG. 9, the system provides impact of any work event planned in the system and that of changes in the work event on a real-time basis. The impact notification includes the impacts on one or many goals, resource balancing, and performance scores (steps 1003, 1004). Due to the impact analysis, supervisor/manager/leader is able to take decision on any kind on change request received for task/process/project.

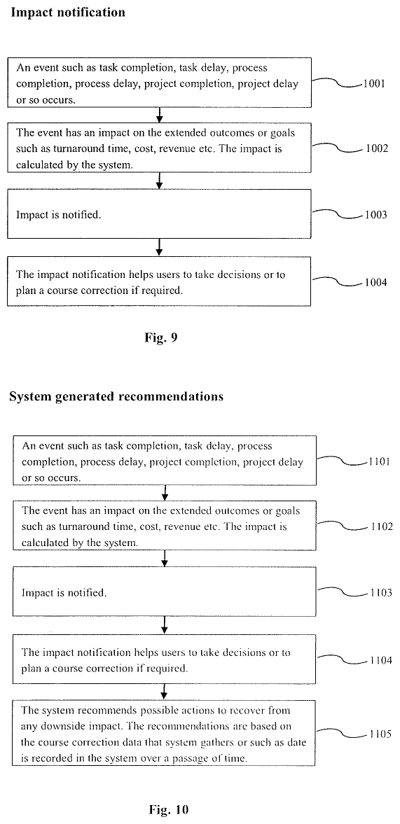

FIG. 10 illustrates steps by which the system of the present invention recommends action steps that will lead to improvements. The system notes down task completion and delay, process completion and delay, project completion and delay (1101). Further, it calculates the impact such delays have on organisation (1102). On one side, the project/process owner/supervisor can take corrective measures (1104), whereas the system, on its own, suggests recommendations to take corrective measure based on course corrective data or through the data gathered over a passage of time (step 1105).

It may be noted that the steps calculation described in the description are carried out by the processor present in the remote server.

Key Features of the invention:

1. Time schedule

The system of the invention automatically assigns the tasks to the individuals based on the defined dependencies. The tasks are designed and scheduled, considering expected turnaround times, quality definitions, implementation budgets, other applicable performance parameters and other interdependencies.

2. Parameter Setting

The requisite parameters to be considered for rating or scoring are decided by the top management of the organization based on their respective business objectives. The parameters are called as Key Performance Indicators (KPI). KPIs may be any measurable performance indicators such as sales, revenue, gross margins, SG&A, free cash flow, PAT and so on.

3. Definitions:

This feature involves consolidating definitions such as tasks to be performed, tasks owner, team member, TAT, quality definition, calendar, performance parameters, organisation hierarchy, escalation hierarchy etc. The definitions are consolidated by the top management of the organization. Further, the task definitions may include task calendar and whether the tasks require only specific dedicated resources or employer/s. The definitions may also include whether tasks are to be assigned to other resources, such as assets, apart from the task executor/s. The task definition also includes an on-site option applied to a resource. The on-site option helps estimate additional on-site cost impact of an idle on-site resource. The on-site option also helps the resource to plan site travel in advance based on information of the site schedule.

Task completion may depend on multiple internal, such as various functions within organisation or multiple branch offices, or external resources, such as vendors/customers. All these stake holders may have different working calendar. Such calendar may be created based on, for example the time zone in which the organisation is situated.

System offers impact analysis for supervisors for helping them to approve extra/rework/hold or for doing resource levelling.

The onsite resource also impacts on various performance parameters such as cost, cash flow, revenue etc.

Hence in task definition, it is necessary to consider whether the resources are on site or at office.

4. Updates of Progress:

The scoring feature offered by the system makes the system self-propelling as the users of the systems get motivated to complete the tasks in the system and update the progress proactively to maintain their scores and to achieve higher scores. It is observed in the other systems without the scoring feature that the users may not effectively use the system and may not complete the tasks in a timely manner.

As the tasks are assigned, the project/process owners may be able to monitor the progress of the tasks and, consequently the project/process through the system of the invention. The project/process owners may include the top management, project leaders, supervisors and such persons who are owners of processes or projects.

The moment tasks are completed as per quality definition, task executor will submit the task for audit approval supporting documents and the process of rating or scoring is initiated thereafter. In a case of a notable mistake during execution of the task, the task will be rejected by auditor and task will reappear on task executor's dashboard. In this case, the system will apply penalty to task executor.

In case of urgency, the task executor may apply for exception from quality definition and submit task without complying few/all quality definitions, if approved by the company. The system records all such instances for the task executor and exception approver and provide analysis/recommendation to supervisors to improve processes/train resources/to avoid misuse of use exceptions.

Once task is approved by auditor, task will be closed and user will get score based on task executors performance on all performance parameters attached to the task. Also tasks dependant on closed task will become live.

If the task executor of dependant task finds notable error in the closed task because of which he/she cannot complete their task, the task executor of dependant task can trigger “rework” or “rework” on the closed task. The project/process owner can verify the “extra/rework” request and approve the “extra/rework” plan. In this case, the system will apply penalty to task executor on reopened task.

If reasonable, the tasks may be put on hold for a re-defined time by the task owner. If the task is proactively released by the task owner from the hold state before the re-defined time gets over, the system offers extra rating/scoring to the task owner.

5. Dependency and Integration:

In case of a task or project that is dependent on a previous task or project, the linkage is established by the system of the invention and consequently planned automatically with quality criteria of present task or project.

6. Resource Planning:

Based on the project or task, along with ongoing project, processes or task, resource availability based on productive expected work hours the system of the invention aids the project/process owner, supervisor to plan the resources. The system indicates the person/s involved in other tasks or projects in order for the task owner to plan the human resources.

7. Resource Levelling:

Based on ongoing projects/processes, resource availability, priority among launched projects/processes, system aids supervisor/project owners/process owners to level the resources. The system provided impact analysis to aid in deciding project/process prioritisation.

8. Task Initiation by the Task Executor:

The task executor may initiate a new task and intimate the same to other potential task executors, if needs be.

9. Process Initiation:

Processes may be auto-triggered for some other task completion, for example Project initiation process after order closure. It may also be triggered manually, for example, resignation process or hiring process or recovery process, or may be automatically triggered on periodic basis, for example statutory compliance process, expense voucher submission process.

10. Survey and Feedback:

The system of the invention provides platform for a survey to the organisation. The system may generate a survey and asks for a rating from the entities that avails services from that particular internal or external customers at the end of every process/project or at predefined frequency as configured by company. The ratings sent by those entities are stored and analysed by the system and conveyed to the organisation. The system will score responsible stake holders based on survey input.

The feedback process is periodically initiated by the system. The system also initiates a follow-up process within the organisation to ensure that feedback is implemented or justified for non-implementation.

The user can also provide proactive feedback to his/her team in case he/she anticipates delays/deviations in expected performance parameters.

11. Leave of absence and loss of pay management:

The system of the invention keeps track of leave of absence and loss of pay of the task executors. The leaves may be Sick Leave/Casual Leave or Privilege Leave. The leave record is used for resource levelling or reassigning the task to ensure that organisation goals are not missed. The data is also used for mapping resource productive benchmark. In case absence of resource, the system of the invention initiates a trigger for the supervisor/project owner to either consider HOLD for a task or reassign the task depending on the priority. The system updates task owners new Turnaround Time (TAT) for the task to be completed based on supervisor/project owner decision. Depending upon the number of task executors on leave, the system efficiently plans resource management.

12. Automated Day Planning:

The system automates day of every individual resource based on all the process/projects initiated in the system, interdependencies of task and priorities among ongoing projects/process. The system of the invention assists the task executors to manage the assignments/tasks. For this purpose, each day of the human resources may be planned by the system.

13. Objective Performance Assessment in a Fair Manner:

The system of the invention ensures that every activity carried out by an individual is aligned with the objectives outlined by the organisation. The system scores every task based on the performance parameters attached to respective task and other actions happened on the task such as rejection, hold, rework, extra and such. Further, the system records rating/scoring for every progressive task. Such rating/scoring is continuously updated and hence eliminates long waiting periods for performance appraisals. The system of the invention further provides complete analysis of the task executor's/individual's performance, providing much needed transparency in the performance assessment. The system provides performance report backed by data at granular level. The Management is not needed to depend on internal hierarchy to know performance of any individual in the organisation.

14. Benchmarking

The system provide benchmarking among resources, teams, functions, levels and even between companies based on all performance data stored in the system. The system also suggests areas of improvement to user

15. Auto Recovery Process

The system of the invention provides configurable platform to set organisation's performance parameters and acceptable deviation. Further, the system initiate automatic recovery process in case there achieved performance is deviated beyond acceptable performance criteria. This ensures that the required action is taken to ensure that organisation objectives are met as planned.

16. Setting up Organisation's Goal/Objective

The system provides configurable platform to set organisation objectives and link it to resources at all levels. This ensures that everything which is happening is the organisation is aligns with organisation's objectives.

Over the period, system of the invention also aids in setting up the organisation's goals based on old performance data and suggests actions needed to be taken based on performance data stored.

17. Process Implementation and Improvement:

As all the task are approved and scored based on quality definition, the system aids companies to ensure that all process are followed. Based on the data gathered from employee performance, system also suggest areas of process improvement to bring more efficient process or highlight needs of training to help effective implementation of processes,

Apart from these features, the invention facilitates a system and method for automated team work which may help a team to execute the task according to the need of the hour.

I claim:

1. An automated system for real time monitoring and enhancing performance for an enterprise in system generated objective manner comprising:
plurality of electronic devices configured to receive proposed tasks and submit completed tasks;
an interface integrating the electronic devices & a remote server; and
a remote server configured to receive, store information relating to the tasks; wherein the remote server is capable of:
defining and standardising plurality of parameters before generating tasks/projects/processes;
determining acceptable deviations from the standardised parameters before generating tasks/projects/processes;
managing resources by verifying availability of executor before assigning the tasks/projects/processes to the executor;
accepting/rejecting the tasks/projects/processes submitted by the executors based on quality;
determining quality of the submitted tasks/projects/processes by verifying whether submitted tasks/projects/processes are within the acceptable deviations from the standardised parameters;
initiating a failure recovery mode if the submitted tasks/projects/processes are not within the acceptable deviations from the standardised parameters;
computing scores and penalties of resources based on quality of tasks/projects/processes;
computing impact on the enterprise in case of delays meeting timeline, rework, change of scope, resource balancing; and
self-generating recommendations based on delays/deviation in performance parameters.

2. The system as claimed in claim 1, wherein the parameters are selected from goals set by enterprise, working hours of the enterprise, expected productive hours of resources, Key Result Area (KRA), Key Performance Indicator (KPI), Turnaround Time (TAT), timeline associated with tasks/projects/processes.

3. The system as claimed in claim 1, wherein management of resources by the remote server comprises of
identifying generated tasks/projects/processes;
identifying executors associated with the tasks/projects/processes;
listing the tasks/projects/processes in current status or future status depending upon priority of tasks/projects/processes;
determining quality submitted tasks/projects/processes; and
accepting/rejecting the submitted tasks/projects/processes.

4. The system as claimed in claim 1, wherein total score relating to tasks/projects/processes, including the executor's individual score, team score, managerial score, are averaged over a period of time by the remote server.

5. The system as claimed in claim 1, wherein the managerial score and penalty is computed by the remote server based on the effective resource management

6. The system as claimed in claim 1, wherein the remote server is selected from a physical server, a cloud server or any other server accessed in a network,

7. An automated method for monitoring and enhancing performance of an enterprise in an objective manner comprising steps of:
defining and standardising plurality of parameters before generating tasks/projects/processes;
determining acceptable deviations from the standardised parameters before generating tasks/projects/processes;
managing resources by verifying availability of executor before assigning the tasks/projects/processes to the executor;
accepting/rejecting the tasks/projects/processes submitted by the executors based on quality;
determining quality of the submitted tasks/projects/processes by verifying whether submitted tasks/projects/processes are within the acceptable deviations from the standardised parameters;
initiating a failure recovery mode if the submitted tasks/projects/processes are not within the acceptable deviations from the standardised parameters;
computing scores and penalties of resources based on quality of tasks/projects/processes;
computing impact on the enterprise in case of delays meeting timeline, rework, change of scope, resource balancing; and
self-generating recommendations based on delays/deviation in performance parameters.

8. The method as claimed in claim 6, wherein the parameters are selected from goals set by enterprise, working hours of the enterprise, expected productive hours of resources, Key Result Area (KRA), Key Performance Indicator (KPI), Turnaround Time (TAT), timeline associated with tasks/projects/processes.

9. The method as claimed in claim 6, wherein step of management of resources comprises of
identifying generated tasks/projects/processes;
identifying executors associated with the tasks/projects/processes;
listing the tasks/projects/processes in current status or future status depending upon priority of tasks/projects/processes;
determining quality submitted tasks/projects/processes; and
accepting/rejecting the submitted tasks/projects/processes.

10. The method as claimed in claim 6, wherein total score relating to tasks/projects/processes, including the executor's individual score, team score, managerial score, are averaged over a period of time.

11. The method as claimed in claim 6, wherein the managerial score and penalty is computed based on the effective resource management
